(19) United States
(12) Patent Application Publication
(10) Pub. No.: US 2003/0188780 A1
(43) Pub. Date: Oct. 9, 2003

(54) Storage tank in a pulp processing plant having freeze resistant overflow and over-pressure/under pressure doors

(76) Inventors: Patrick J. Sullivan, Argyle, NY (US); Patrick J. Pepin, Queensbury, NY (US); Joseph R. Phillips, Queensbury, NY (US)

Correspondence Address: NIXON & VANDERHYE, PC, 1100 N GLEBE ROAD, 8TH FLOOR, ARLINGTON, VA, 22201-4714, US

(21) Appl. No.: 10/388,240

(22) Filed: Mar. 14, 2003

Related U.S. Application Data
(60) Provisional application No. 60/369,848, filed on Apr. 5, 2002.

(51) Int. Cl. F16K 49/00

(52) U.S. Cl. 137/334

(57) ABSTRACT

A low pressure tank is disclosed having: an upper section with a sloping surface; a port on the surface; a gable housing covering the port and having a front face oriented generally vertically; an aperture in the front face; a door aligned with and covering the aperture in the front face, and a door hinge above and aligned with the door and horizontally offset from said front face.

### RELATED APPLICATION

Priority is claimed to Provisional Application 60/369,848, filed Apr. 5, 2002, the entirety of which is incorporated by reference.

### FIELD OF THE INVENTION

The present invention relates to overflow, pressure relief and vacuum relief ports on low-pressure chemical tanks. In particular, the invention relates to tanks, such as pulp storage tanks, in pulp processing plants that have pressure relief, vacuum relief and overflow relief doors.

### BACKGROUND OF THE INVENTION

Low-pressure tanks are common in many chemical and industrial processes. For example, a pulp storage tank is typically used to store pulp at various locations within the system. These tanks can be used in storing various compounds including chemically produced cellulosic fibrous pulp, mechanically produced pulp, recycled fiber, etc. The tanks are typically used after the cellulosic fibrous material has been processed in a digester, using the chemical process both batch and continuous, mechanical process, thermo-mechanically processes, or material which has been re-fiberized in a recycle facility.

Storage tanks typically have outlets around their upper periphery that provide overflow fluid relief, and vacuum or over-pressure relief. These relief outlets are typically openings in the upper housing of the storage tank which allow fluid to flow out of the storage tank, when the fluid level in the storage tank becomes excessively high. In addition, these openings may draw air into the tank for vacuum protection. These openings may be covered by gables (also known as dormers) on the top of the storage tank. The gables have an open vertical front face with a hinged door. Each overflow opening has a door that remains shut over the overflow opening until fluid fills the tank and flows out of the opening. The doors on the overflow openings prevent debris, rain, snow and ice from falling into the storage tank. The doors also reduce the amount of ambient air drawn into the tank as well as serving to prevent fluid splashing within the storage tanks from spilling out of the tank during non-overflow conditions.

Similarly, storage tanks may have one or more openings for vacuum or pressure relief. The tank operates at near atmospheric conditions. An over- or under-pressure condition may be where the pressure in the tank is either greater than atmospheric pressure or less than atmospheric pressure. A greater than two psi pressure (or 4 inches of water vacuum) variation in a storage tank may be sufficient to damage the tank or result in a dangerous operating condition. The pressure relief openings are normally closed by doors on the storage tank. If the pressure in the storage tank becomes excessive, the pressure forces the doors open and gases and fluids are allowed to flow out of the pressure relief apertures on the tank.

The metal doors on the overflow fluid, e.g., front face of the gables, and pressure relief openings tend to be noisy when they clang against the walls of the storage tank. Another difficulty with these doors is that they may freeze shut during winter conditions. A further difficulty is that the doors lack good seals with the vessel and allow gases from the vessel to escape to the atmosphere during normal operation. Escaping gases may lead to environmental concerns. One previous tank modification has been to replace the doors with flexible flaps that avoid the loud noises caused by metal doors. But, these flaps tend to wear out relatively quickly and do not effectively seal the contents of the storage tank during normal operation from the outside environment, or even worse fall into the tank.

There is a long-felt need for doors on tanks that effectively seal the tank during normal operations, and allow excessive fluid levels to overflow out of the tank and excessive or under-pressure conditions to be relieved. There is also a need for a door seal that prevents gases inside the tank from seeping out of the tank as well as preventing excessive amounts of air from getting into the tank, during normal tank operation. There is a further need for a door on a tank that reliably operates in extreme environmental conditions, such as during freezing conditions.

### BRIEF DESCRIPTION OF THE INVENTION

Doors have been developed for overflow, pressure relief and vacuum relief outlets on a tank, such as a storage tank. The metal doors are hinged such that the door hinge and door are offset from a front wall of a gable of the tank. The front wall added to the vertical front face of the gable has an opening for fluid or gases to pass, and a frame surface surrounding the opening. The door abuts against a seal strip on the door or frame surface. The door hinge is adjustable with respect to the gable, so that the door can be properly seated against the gable front wall and over the opening in that wall. The door has an area larger than the overflow or pressure opening in the front wall. The outer periphery of the door abuts the front wall of the gable adjacent and surrounding the aperture. The door may be mounted inside or outside the seal strip to provide the appropriate under-pressure or over-pressure protection.

The outer periphery of the door (or the front wall on the gable) has a seal, such as a Gortex™ or a sponge rubber equivalent that provides a gaseous seal between the door and front wall of the gable. Moreover, the door may have mounted thereon a weight that biases the door in a closed position, or the door may be attached to the hinge so that the weight of the door itself maintains the door in a closed position. The door weight and angle must be properly engineered to allow the door to open adequately to provide the desired relief flow at the target pressure or vacuum relief setting.

In one embodiment, the invention is a low pressure tank having: an upper section with a sloping surface; a port on the surface; a gable housing covering the port and having a front face oriented generally vertically; an aperture in the front face; a door aligned with and covering the aperture in the front face, and a door hinge above and aligned with the door and horizontally offset from said front face.

In another embodiment, the invention is a low pressure tank comprising: an upper section with a sloping surface; a plurality of dual purpose pressure relief fluid overflow ports on the sloping surface, wherein these ports are aligned horizontally; a plurality of vacuum relief ports on the sloping surface, wherein the relief ports are aligned horizontally in a plane vertically above the pressure relief overflow ports; a separate gable housing covering each overflow port and relief port, and each gable housing having a front face oriented generally vertically; an aperture in each front face; a door aligned with and covering each aperture; a door hinge supporting and above the door, and horizontally offset from the corresponding front face.

### BRIEF DESCRIPTION OF THE DRAWINGS

The invention is illustrated in the attached drawings, wherein:

FIG. 1 is a side view of a storage tank used in a pulp mill system.

FIG. 2 is a top plan view of the storage tank shown in FIG. 1.

FIGS. 3 and 4 are enlarged views of sections A and C, respectively, of the front tank to show the gable section of the storage tank shown in FIG. 1.

FIG. 5 is an enlarged cross-sectional side view of the front opening and door for a gable section for a vacuum opening.

FIG. 6 is an enlarged cross-sectional side view of the front opening and door for a gable of an overflow opening.

### DETAILED DESCRIPTION OF THE INVENTION

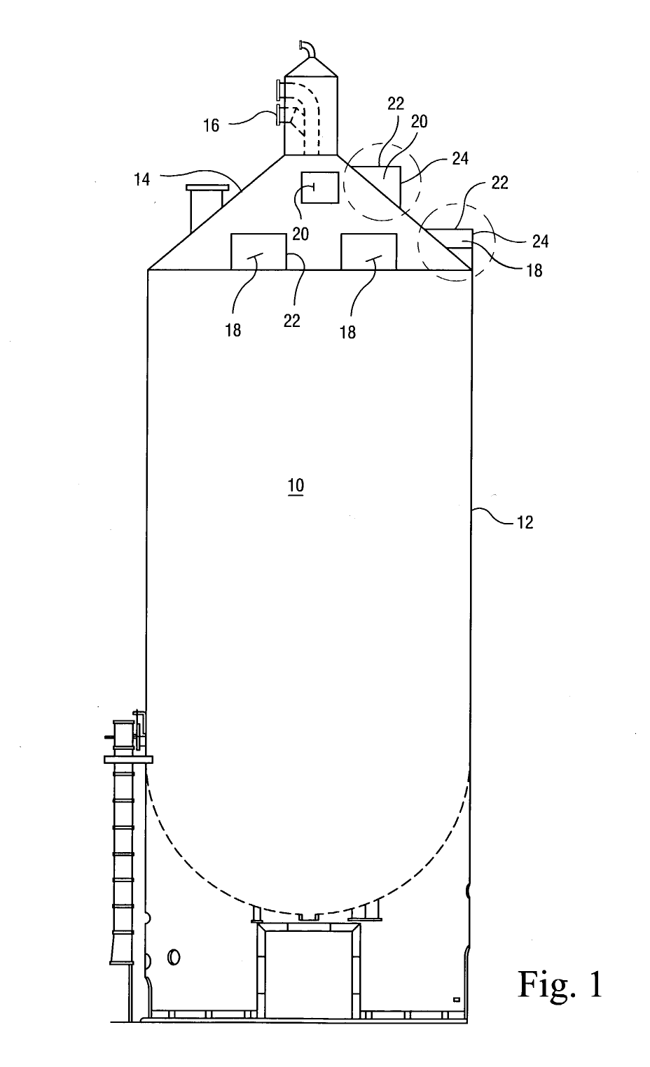

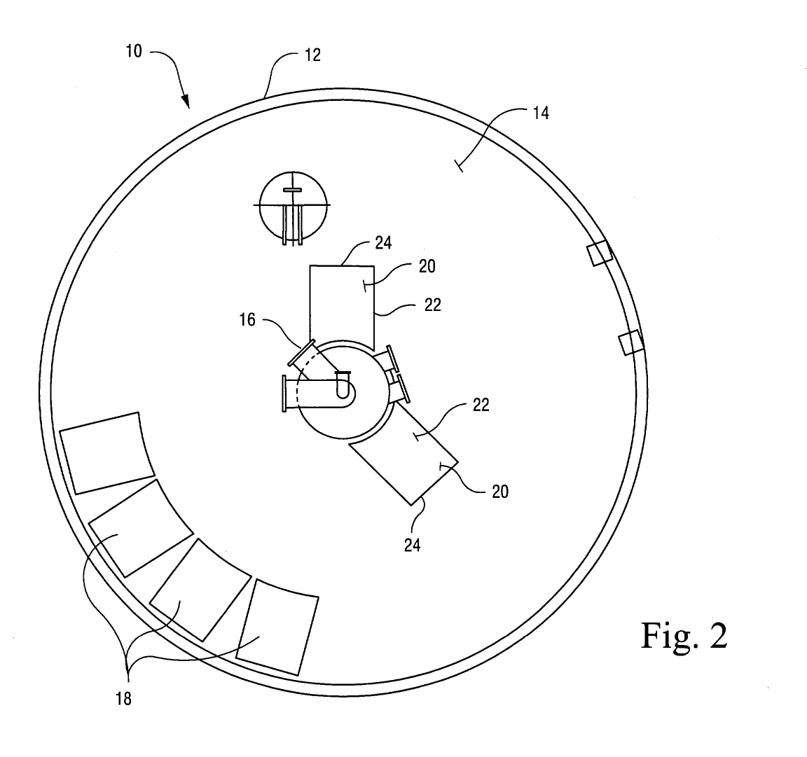

FIGS. 1 and 2 show a storage tank 10 having a cylindrical portion 12 and a conical upper portion 14. The tank 10 may operate normally at a relatively-low pressure such as two pounds per square inch (psi) or less (or 4 inches of water vacuum) and have typically a combined gaseous and fluid content. Pulp enters an inlet 16 at the top of the relatively-low pressure chamber inside of the storage tank 10. Other inlet configurations also exist. The volume of the tank 10 is generally filled with a fluid under relatively-low pressure, such as at atmospheric pressure.

The walls of the cylindrical portion 12 and upper portion are solid with the exception of outlet ports 18 that provide fluid overflow protection and relief of external overpressure (these doors swing outward) and ports 20 that provide for vacuum relief (over 4 inches of water vacuum in the tank can cause damage to the tank, these doors swing inward). The ports 18, 20 are not drawn to scale in FIG. 1. The upper ports, 20, are for vacuum relief while the lower ports, 18, provide fluid overflow protection and relief of external overpressure.

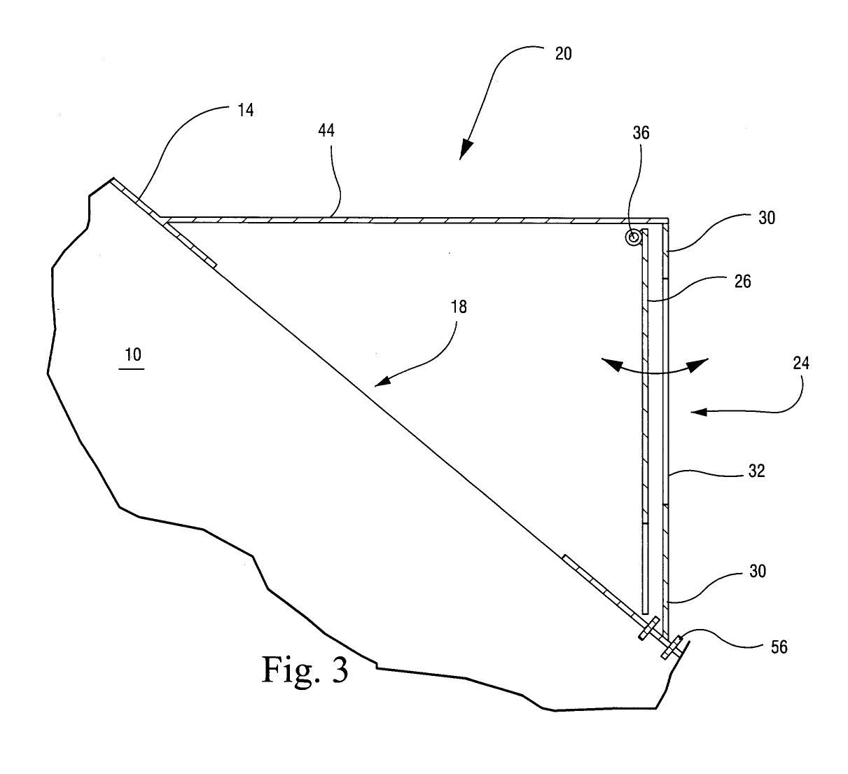

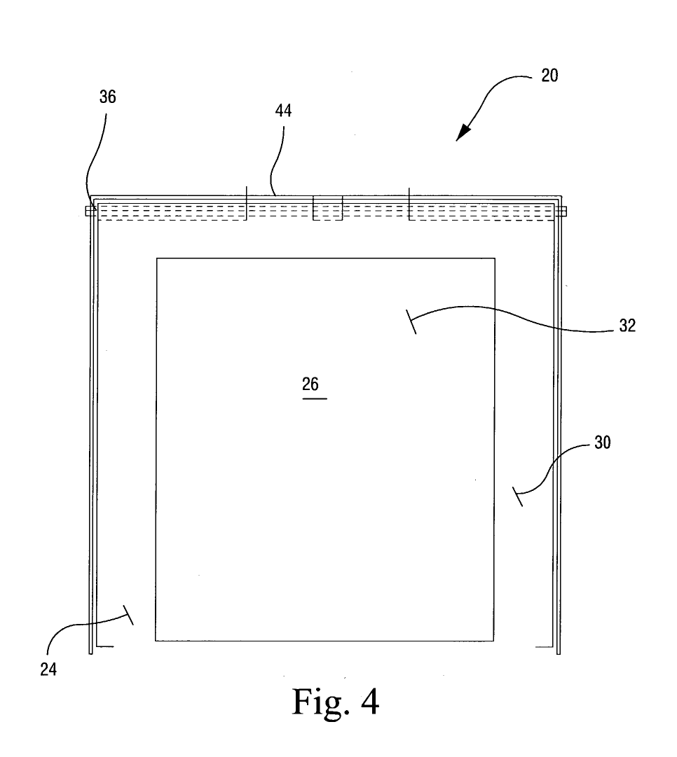

The overflow ports 18 are generally all at similar elevations within the tank such that they all allow excess fluid to flow out of the tank when the fluid reaches an overflow level. The tank upper section 14 has openings protected by gable sections 22 which are, in turn, open to the atmosphere. A door 26 (see FIGS. 3 and 4) on the front 24 of the gable closes the openings to the tank, during normal conditions.

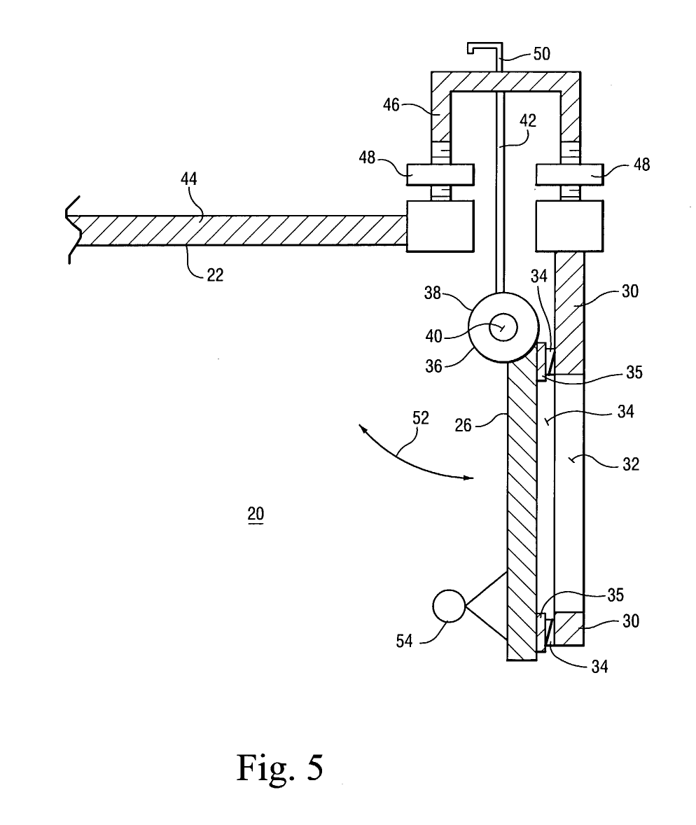

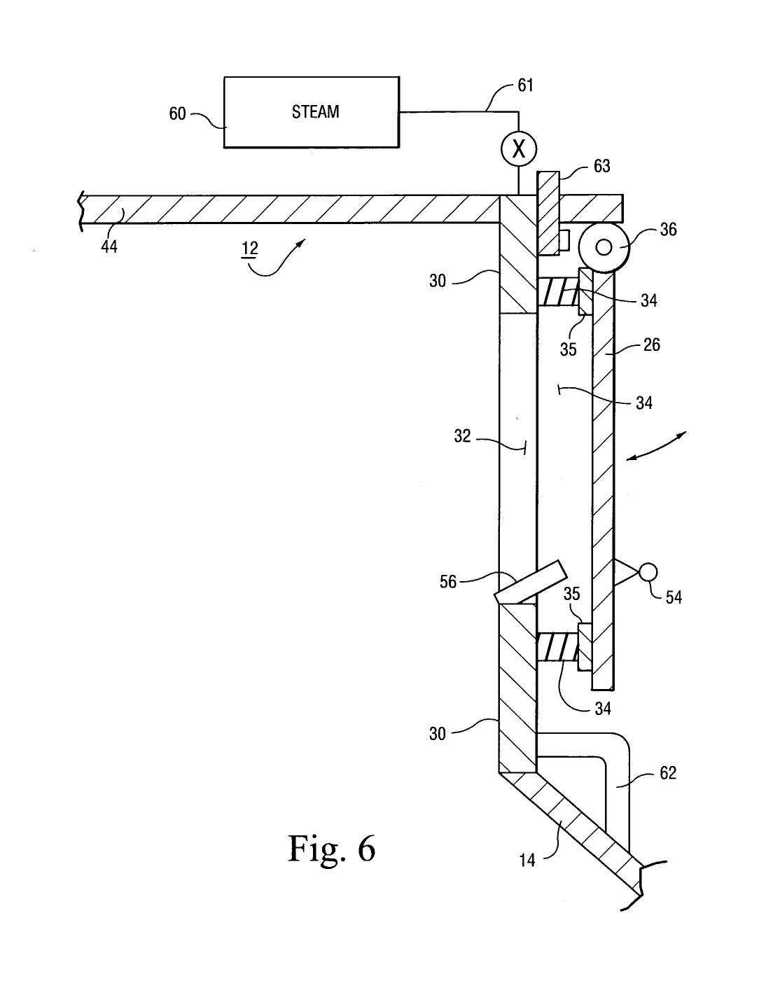

As shown in FIGS. 3 and 4, the overflow and pressure relief ports 18, 20 are each covered by the gable section 22 (also known as a dormer) of the upper portion 14 of the wall of the tank. The gables are a rectangular section extending from the upper section 14. The gables have a generally-vertical face 24 having a frame surface 30 with an aperture 32, and a door 26 (see FIGS. 5 and 6).

The external pressure (vacuum) relief openings 20 are at a generally higher elevation on the top 14 of the storage tank than are the overflow openings 18. A first pressure relief opening 20 safeguards the tank against an over-pressure condition in the tank and allows excess external pressure in the tank, e.g., below 2 inches water vacuum, to cause a door 26 over the opening (see FIG. 5) to swing inwardly to the tank and allow air to be drawn in through the pressure opening 18. The second pressure relief opening 20 safeguards the tank against an excessive vacuum condition, and will allow outside air to enter the storage tank if the pressure in the storage tank falls sufficiently below atmospheric pressure to cause the door 26 on the inside of the tank to swing open and allow air to flow in through the second pressure relief aperture.

Previous gable doors did not seat against a wall surface on the gable. Rather, the front face of the gable was completely open and only the door covered the gable front. An improvement achieved by the doors and gables disclosed herein is that the doors 26 seat against a vertical wall 30 on the front face of the gable. This vertical wall 30 has an opening 32 for overflow fluids and pressure relief.

Further, previous doors on the tank for either vacuum or overflow relief hung inline with the tank wall. Having the hinge for the door in line with the front face of the gable can cause binding of the door and prevent its use for the intended purpose. The prior doors had a 0.5 inch gap around the door on three sides of the gable. The fourth side (the top) contained the door hinges. The gap between the gable and door allowed gases to seep out from the tank, through the gable and into the atmosphere.

A new door 26, hinge 36 and front gable face 30 has been developed for pressure/vacuum relief and for overflow on tanks. The doors are no longer mounted inline with the front face of the gable. In addition, the doors are hinge mounted from a point higher than the opening in the front face 30 of the gable. The door frame includes a seal 34, made of Gortex(TM) or similar elastic material, that extends around all sides of the opening 32 in the gable front face. The hinge 36 for these doors is now located above the opening and allows for a pivot point to open the door which will not stick.

FIG. 5 is a cross-sectional view of a portion of the gable 22 which shows the door 26 on the front face 30 of the gable. This door and gable are for a vacuum relief port 20 and is mounted higher on the tank top 14 than is the overflow port 18. The front face of the gable includes a frame 30 formed of a metal plate having a center opening 32. The center opening 32 allows gases to escape from the tank or air to enter the tank during over- or under-pressure conditions. The opening 32 in the gable front face 30 is sealed by the door 26 during normal tank operation. The door hinge 36 is mounted to swing shut against the front face 30 of the gable and thereby seal the opening 32. To promote sealing, a Gortex™, or equivalent, strip 34 is attached to the front surface of the door. Alternatively, the strip may be mounted on the front gable face 30. The strip may be mounted on a metal spacer 35 that provides elevation to the spacer which may be needed to bridge the gap between the door 26 and front face 30.

The Gortex™ strip 34 presses against the inner surface of the gable front face 30 when the door is closed. The Gortex™, or equivalent, strip may form a continuous strip that extends around the opening 32 when the door is closed. When the door is closed, the Gortex™ strip promotes a seal between the door and gable front face 30 which prevents gases from escaping out of the tank into the atmosphere. A heat trace, e.g., steam or electric heat, is included on the door or front face to heat them and thereby avoid freezing of the door to the front face.

The door 26 is mounted on a hinge 36. The hinge may comprise a cylinder 38 that is bolted or welded to a top edge of the door 26, and a rod 40 extending through the cylinder that is mounted by a bracket 42 to the top of the gable 44. The hinge bracket 42 is attached at an upper end to a hinge box 46 at the upper forward edge of the gable. The hinge box may be secured by bolts 48 to the top forward portion of the gable.

The bolted connection 48 between the bolt box 46 and gable top 44 provides a vertically adjustable connection between the bolt box and gable. The vertical adjustment allows the vertical position of the door to be adjusted to properly position the door 26 over the opening 32 and ensure that the Gortex™, or equivalent, strip 34 properly seats on the gable front face 30 and around the opening 32. A lifting hook 50 on the bolt box 46 provides a means for removing the hinge and door vertically through the gable by unbolting the bolt box and lifting the bolt box by the lifting hook.

The door 26 in FIG. 5 is inward of the front frame 30 of the gable 22. The door is not in the plane of the front face of the gable or any wall of the tank. The door 26 swings inward (see arrow 52) when the pressure in the tank, and hence the interior of the gable, drops sufficiently below atmospheric pressure such that the pressure difference acting on the door causes the door to swing about its hinge 36. To ensure that the door does not unnecessarily swing open, the door may be weighted 54, or attached to the hinge, such that the door is biased towards a closed position where the door seats against the front face 30 of the gable.

The lower edge of the opening 32 on the front face of the gable may include a drip lip 56. The drip lip catches fluid streaming down the front face 30 of the gable, and deflects fluid back into the storage tank where the fluid falls from the front gable face 30 vertically through the opening 32.

The pressure relief door 56 shown in FIG. 5 swings inwardly when an excessive vacuum forms in the tank. A second pressure relief door may be arranged on a second gable 22 in the tank to provide over-pressure relief from the tank. This second door would be mounted on the outside surface of the front gable face 30, (as shown in FIG. 6) in contrast to the inside surface mounting of the vacuum relief door. To allow for proper mounting of the hinge box 46 on the top of the gable for the over-pressure port 20, the top of the gable 44 may overhang beyond the front face 30 of the gable.

FIG. 6 shows an embodiment of the door and gable which are specifically designed for the overflow port 18. The door 26 is mounted by a hinge 36 that is bolted to the top of the top edge 44 of the gable. The door hangs vertically down across the front face 30 of the gable. The door covers the opening 32 of the gable. A Gortex™, or equivalent, strip 34 extends continuously around the opening 32 and seals against the front surface of the gable wall 30. The Gortex™, or equivalent, strip 34 may be sufficiently thick so as to ensure the door does not bang against the drip lip 56 on the lower edge of the opening 32 of the gable wall 30. An adjustable hinge bracket 63 is bolted to the gable and supports the door hinge 36. The bracket allows the vertical and horizontal position of the hinge and hence door to be adjusted.

The gable wall 30 and door (one or the other or both) are heated with steam or an electrical heating system. By heating the door and front face of the gable, freezing of the door is eliminated or substantially reduced. A steam source 60 is coupled via a pipe 61 and valve to the front face 30 of the gable. The steam line is routed via conduits across the front face 30 so as to heat the front face and door. A steam or water drain 62, at the bottom of the front face 30, drains steam and water from the gable back into the tank.

To prevent freezing of material in the area of the seal, heat tracing is included on the door 26 or gable wall 30. This heat tracing could be either electric or steam, such as a steam source 60. The heat tracing would be installed such that the seal 34 is separated from the back of the heat-traced material. For the “swing out” doors (overflow doors), the electric heat tracing would be mounted on the outside of the door. For the overflow doors using steam for heat tracing, heat-tracing material would be mounted on the tank wall or the door frame. On the “swing in” doors (vacuum doors) FIG. 5, the heat tracing would always be mounted on the tank wall.

To enhance the ability to provide a tight seal around the door 26 and to afford easy access for maintenance, the door 26 is designed to be a bolt-on unit (rather than welded onto the tank). This bolt-on unit, e.g., housing 46, or bracket 63, can be easily removed for maintenance and can allows for the adjustment of alignment to in sure proper (flush) alignment of the seals and the door.

The moving of the door hinge to a higher location than the door opening 32 allows for several improvements. Had the hinge been at the level of the opening 32, the hinge would have either a part of the seal or required to go through the seal 34 and thereby causing a link around the hinge. Moving the hinge away from the opening 32 avoids the need for a link point. At the higher location, the hinge can pivot away from the tank. Finally, because the hinge is freer, it does not bind.

An additional feature of the new door is the ability of the door to have a center of gravity away from the seal surface. These doors are designed to push against the seal. One way to accomplish this is to locate a small weight 54 on the back (opposite the seal face) of the door.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A low pressure tank comprising:
an upper section with a sloping surface;
a port on the sloping surface;
a gable housing covering the port and having a front face oriented generally vertically, wherein the gable housing is on the sloping surface;
an aperture in the front face of the gable housing;
a door aligned with and covering the aperture in the front face;
a door hinge above and aligned with the door and horizontally offset from said front face.

2. A low pressure tank as in claim 1 wherein said door is offset inward of an inside surface of the front face, and said door swings inwardly to relieve an under-pressure in the tank.

3. A low pressure tank as in claim 1 wherein said door is offset outward of an outside surface of the front fact, and said door swings outwardly to allow excess fluid to flow out of the port and through the door.

4. A low pressure tank as in claim 1 wherein said front face includes a heat strip around the aperture and aligned with the door.

5. A low pressure tank as in claim 4 wherein the heat strip is a steam line.

6. A low pressure tank as in claim 4 wherein the heat strip is an electrical resistance line.

7. A low pressure tank as in claim 1 wherein said door includes a weight attached to a side of the door opposite to the front face.

8. A low pressure tank as in claim 1 wherein said door includes a seal on a side facing the front face and extending around the aperture when the door is closed against the front face.

9. A low pressure tank as in claim 1 wherein the door hinge is adjustable vertically up and down to align the door with the aperture in the front face.

10. A low pressure tank comprising:
an upper section with a sloping surface;
a plurality of fluid overflow ports on the sloping surface, wherein the overflow ports are aligned horizontally;
a plurality of pressure relief ports on the sloping surface, wherein the relief ports are aligned horizontally in a plane vertically above the overflow ports;
a separate gable housing covering each overflow ports and the relief ports, and each gable housing having a front face oriented generally vertically;
an aperture in each front face;
a door aligned with and covering each aperture;
a door hinge supporting and above the door, and horizontally offset from the corresponding front face.

11. A low pressure tank as in claim 10 wherein each door is offset inward of an inside surface of the front face, and said door swings inwardly to relieve an under-pressure in the tank.

12. A low pressure tank as in claim 10 wherein said door is offset outward of an outside surface of the front fact, and said door swings outwardly to allow excess fluid to flow out of the port and through the door.

13. A low pressure tank as in claim 10 wherein said front face includes a heat strip around the aperture and aligned with the door.

14. A low pressure tank as in claim 13 wherein the heat strip is a steam line.

15. A low pressure tank as in claim 13 wherein the heat strip is an electrical resistance line.

16. A low pressure tank as in claim 10 wherein said door includes a weight attached to a side of the door opposite to the front face.

17. A low pressure tank as in claim 10 wherein said door includes a seal on a side facing the front face and extending around the aperture when the door is closed against the front face.

18. A low pressure tank as in claim 10 wherein the door hinge is adjustable vertically up and down to align the door with the aperture in the front face.
